(19) United States
(12) Patent Application Publication
(10) Pub. No.: US 2008/0087153 A1
(43) Pub. Date: Apr. 17, 2008

(54) Table sliding arrangement for power saw machine

(76) Inventor: Wy Peron Lee, Riverside, CA (US)

Correspondence Address: Raymond Y. Chan, Suite 128, 108 N. Ynez Avenue, Monterey Park, CA, 91754, US

(21) Appl. No.: 11/580,141

(22) Filed: Oct. 11, 2006

(51) Int. Cl. B23D 19/00

(52) U.S. Cl. 83/435.11; 83/490

(57) ABSTRACT

A power saw machine includes a cutting head, a cutting table, a supporting frame, and a table sliding arrangement for guiding the cutting table to slide on the supporting frame. The table sliding arrangement includes two sliding tracks, a plurality of sliding wheels and a plurality of alignment wheels. The two sliding tracks are spacedly provided at the supporting frame, wherein each of the sliding tracks has an upper surface defining a top sliding channel therealong and an inner side surface defining a side sliding channel therealong. The sliding wheels are rotatably, horizontally and spacedly mounted underneath the cutting table to slide along the side sliding channels of the sliding tracks respectively, wherein the cutting table is slidably engaged with the two side sliding channels of the sliding tracks to prevent the cutting table from being flipped over when the cutting table is slid on the supporting frame.

### BACKGROUND OF THE PRESENT INVENTION

1. Field of Invention

The present invention relates to a saw machine, and more particularly to a saw machine comprising a table sliding arrangement which allows a cutting table to slide on a supporting frame in a stable and balanced manner without risking to flip over.

2. Description of Related Arts

A conventional power saw machine comprises a cutting head, a supporting frame which suspendly and adjustably support the cutting head thereabove, and a cutting table slidably connected with the supporting frame for supporting a work piece thereon. The cutting table will then slide on the supporting frame for aligning the working piece with the cutting head in order to accomplish a desired cutting process.

In order to facilitate the sliding movement of the cutting table, it comprises a plurality of sliding wheels spacedly mounted thereunder for vertically engaging with two sliding tracks formed on the supporting frame, wherein the sliding wheels are arranged to slide along the sliding tracks for slidably connecting the cutting table with the supporting frame.

There are three major problems for this conventional power saw machine. First, since the cutting table is solely supported by the sliding wheels, when it is slid away from the supporting frame, presumably for the purpose of cutting a large work piece, the cutting table would become unstable and risks flipping over. This is because when the power saw machine is operating, the cutting table is subject to vigorous vibration and if the cutting table is not properly supported, it will become very unstable. The upside of this phenomenon is that the instability will severely jeopardize the quality of the cutting process in question, and the downside is that the entire cutting table will flip over and cause damage to the power saw machine, the work piece, the platform on which the power saw machine is supported, and most importantly, personal injury.

Second, a conventional sliding wheels usually has a central rotating portion and two rim portions integrally and raidally extended from the central rotating portion to form a sliding channel between the rotating portion and the rims portions, wherein the sliding track is slidably engage with the sliding channel for slidably connecting the cutting table with the supporting frame of the power saw machine. The problem with this structure is that there is substantial lateral damage on the part of both the sliding track and the rim portions of the sliding wheel. The result is that when time goes by, the sliding movement of the cutting table will become unsmooth, unstable and hard to perform fine adjustment, so as to render the operation of the power saw machine more difficult and the performance thereof worse off.

Third, for conventional power saw machine, when one needs to cut a bigger work piece, he or she needs a bigger cutting table, and a bigger cutting table means a bigger supporting frame. As a result, the application of conventional power saw machine is severely limited by its size. In particular, the user can only cut a work piece having a bigger size by a bigger power saw machine. This is economically unsound and he or she may not always have enough space for installing a bigger power saw machine.

### SUMMARY OF THE PRESENT INVENTION

A main object of the present invention is to provide a power saw machine which comprises a table sliding arrangement which allows a cutting table to slide on a supporting frame in a stable and balanced manner without risking to flip over.

Another object of the present invention is to provide a power saw machine which comprises a table sliding arrangement comprising a plurality of sliding wheels and alignment wheels which are arrange to guide and support the sliding movement of the cutting table for accomplish a stable and balanced sliding thereof.

Another object of the present invention is to provide a power saw machine which comprises a table sliding arrangement, wherein the sliding wheels are arranged to engage with a plurality sliding runners for minimizing lateral damage of the wheels and a supporting frame of the power saw machine. In other words, the present invention makes the entire power saw machine more durable and the cutting table more easily to slide.

Another object of the present invention is to provide a power saw machine which comprises a table sliding arrangement which is capable of facilitating the cutting table to be slid out to a farther extent with respect to the supporting frame as compared with conventional power saw machine.

Accordingly, in order to accomplish the above objects, the present invention provides a power saw machine, comprising:
a cutting head;
a cutting table;
a supporting frame supporting the cutting head; and

a table sliding arrangement, for guiding the cutting table to slide on the supporting frame, which comprises:

two sliding tracks spacedly provided at the supporting frame, wherein each of the sliding tracks has an upper surface defining a top sliding channel therealong and an inner side surface defining a side sliding channel therealong;

a plurality of sliding wheels rotatably, horizontally and spacedly mounted underneath the cutting table to slide along the side sliding channels of the sliding tracks respectively, wherein the cutting table is slidably engaged with the two side sliding channels of the sliding tracks to prevent the cutting table from being flipped over when the cutting table is slid on the supporting frame; and

a plurality of alignment wheels spacedly, vertically and rotatably mounted underneath the cutting table to slide along the top sliding channels of the sliding tracks respectively so as to ensure an alignment of the cutting table to slide on the supporting frame.

These and other objectives, features, and advantages of the present invention will become apparent from the following detailed description, the accompanying drawings, and the appended claims.

### BRIEF DESCRIPTION OF THE DRAWINGS

FIG. 1 is a side view of a power saw machine according to a preferred embodiment of the present invention.

FIG. 2 is a perspective view of the sliding wheel of the power saw machine according to the above preferred embodiment of the present invention.

FIG. 3 is a front view of the sliding wheel of the power saw machine according to the above preferred embodiment of the present invention.

FIG. 4 is a schematic diagram of the power saw machine according to the above preferred embodiment of the present invention, illustrating that the cutting table can be slid out to a farther extent as compared with conventional power saw machine.

FIG. 5 is a first alternative mode of the table sliding arrangement according to the above preferred embodiment of the present invention.

FIG. 6 is a second alternative mode of the table sliding arrangement according to the above preferred embodiment of the present invention.

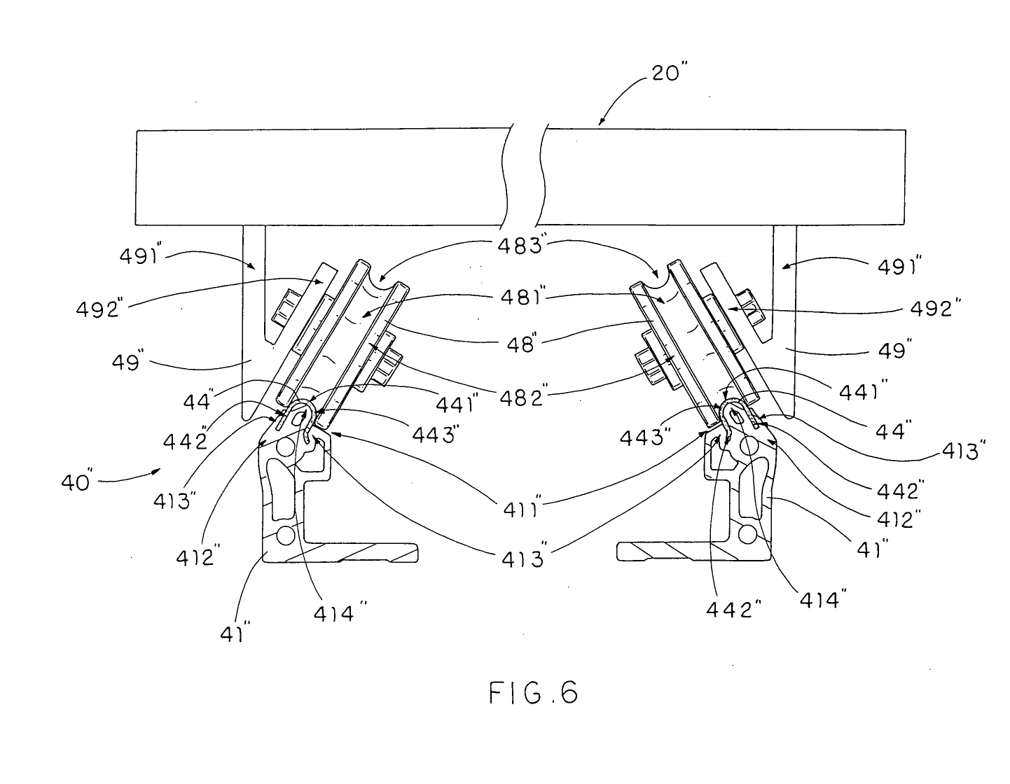

### DETAILED DESCRIPTION OF THE PREFERRED EMBODIMENT

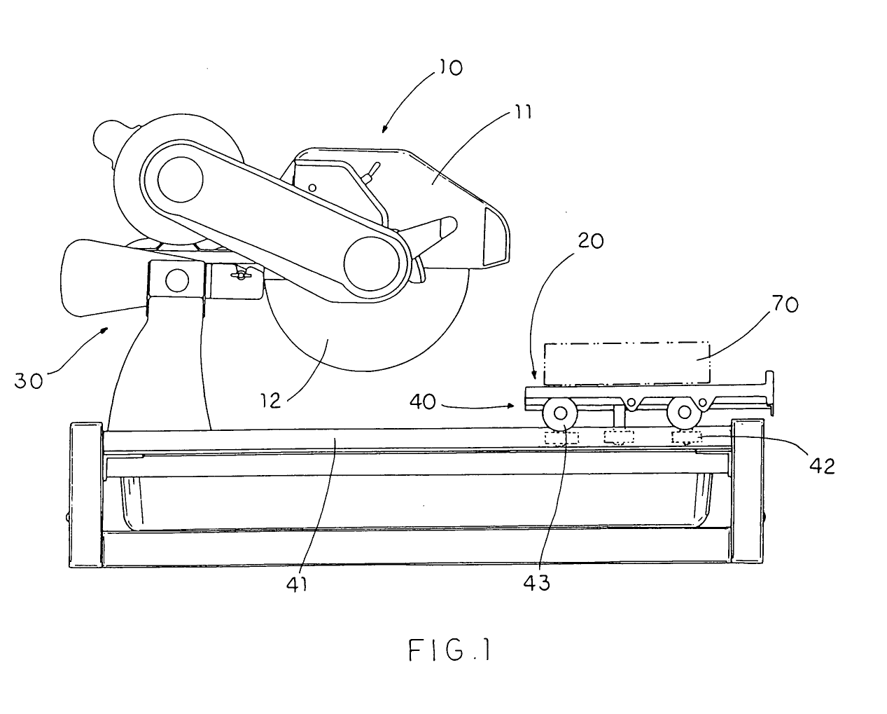

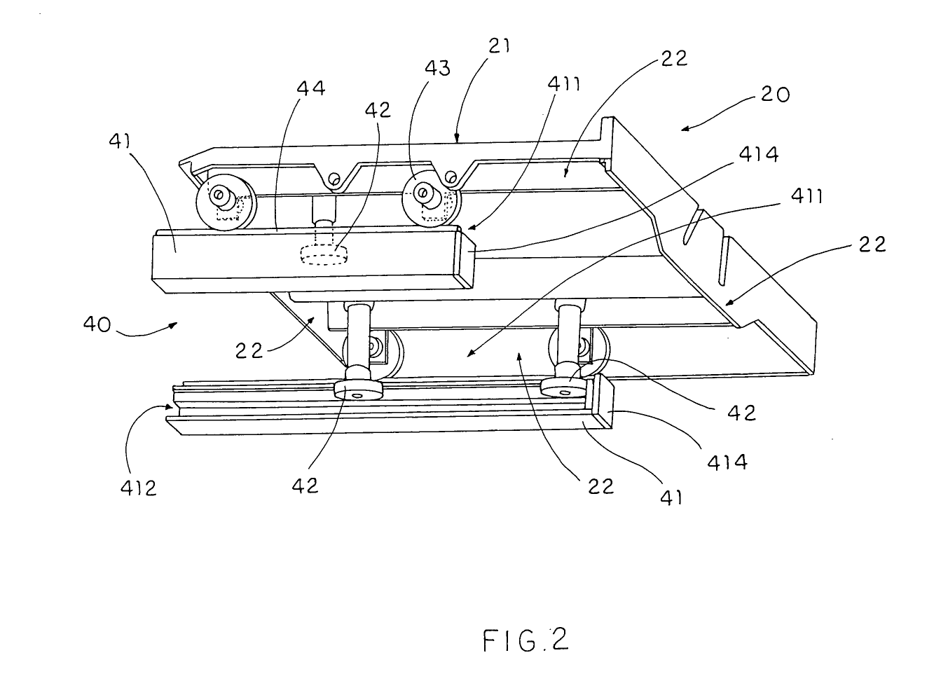

Referring to FIG. 1 to FIG. 4 of the drawings, a power saw machine according to a preferred embodiment of the present invention is illustrated, in which the power saw machine comprises a cutting head 10, a cutting table 20, a supporting frame 30 supporting the cutting head 10, and a table sliding arrangement 40.

The cutting head 10 is preferably embodied as a conventional cutting head comprising a main housing 11 and a cutting blade 12 rotatably mounted at the main housing 11 for cutting the work piece 70 on the cutting table 20.

The table sliding arrangement 40 is for guiding the cutting table 20 to slide on the supporting frame 30, and comprises two sliding tracks 41, a plurality of sliding wheels 42, and a plurality of alignment wheels 43.

The two sliding tracks 41 are spacedly provided at the supporting frame 30, wherein each of the sliding tracks 41 has an upper surface defining a top sliding channel 411 therealong and an inner side surface defining a side sliding channel 412 therealong.

The plurality of sliding wheels 42 is rotatably, horizontally and spacedly mounted underneath the cutting table 20 to slide along the side sliding channels 412 of the sliding tracks 41 respectively, wherein the cutting table 20 is slidably engaged with the two side sliding channels 412 of the sliding tracks 41 to prevent the cutting table 20 from being flipped over when the cutting table 20 is slid on the supporting frame 30.

The plurality of alignment wheels 43 is spacedly, vertically and rotatably mounted underneath the cutting table 20 to slide along the top sliding channels 411 of the sliding tracks 41 respectively so as to ensure an alignment of the cutting table 20 to slide on the supporting frame 30.

According to the preferred embodiment of the present invention, the table sliding arrangement 40 further comprises a sliding runner 44 received in the top sliding channel 411 of the sliding tracks 41 for engaging with the sliding wheels 42 in such a manner that when the sliding wheels 42 slide on the sliding tracks 41, the sliding runners 44 prevent direct physical contact between the sliding tracks 41 and the sliding wheels 42 so as to minimize collateral damage of the sliding wheels 42 and the sliding tracks 41.

Each of the alignment wheels 43 has a central portion 431 and two side rim portions 432 having a diameter larger than a diameter of the central portion 431 to define a guiding groove 433 between the central portion 431 and the side rim portions 432 for slidably engaging with the respective sliding runners 44 received in the top sliding channel 411, and so for ensuring the alignment of the cutting table 20 with respect to the sliding tracks 41 when the cutting table 20 slides on the supporting frame 30.

Each of the sliding tracks 41 has a sliding groove 413 indently formed along the side sliding channel 412 and arranged in such a manner that the sliding wheels 42 are slidably engaged with the sliding grooves 413 to slide along the side sliding channel 412 respectively so as to prevent an unwanted sideward movement of the cutting table 20 when the cutting table 20 slides on the supporting frame 30.

Each of the sliding runners 44 has a convex outer surface 441 which is arrange to physically contact with the corresponding sliding wheels 42 at an inner surface of the side rim portions 432 and an outer surface of the central portion 431 for maximizing a contact surface area between the sliding runner 44 and the respective sliding wheels 42 in order to minimize collateral damage between the sliding wheels 42 and the sliding runners 44. In other words, the sliding wheels 42 will be kept in good condition for prolonged usage of the power saw machine of the present invention.

In order to stabilize the sliding movement of the cutting table 20, a width of each of the guiding grooves 433 is merely slightly larger than a width of the convex outer surface 441 of the corresponding sliding runners 44 so that when the sliding wheels 42 are engaged with the sliding runners 44 respectively, a collateral movement between the sliding wheels 42 are substantially restricted by the width of the guiding grooves 433 so as to stabilize the sliding movement of the cutting table 20.

It is important to point out at this stage that since the sliding wheels 42 are horizontally and rotatably engaged with the corresponding side sliding channel 412, when the cutting table 20 slides on the supporting frame 30, two outer sides of the sliding wheels 42 will effectively restrict a flipping tendency of the cutting table 20 so as to prevent it from flipping over during a typical cutting process.

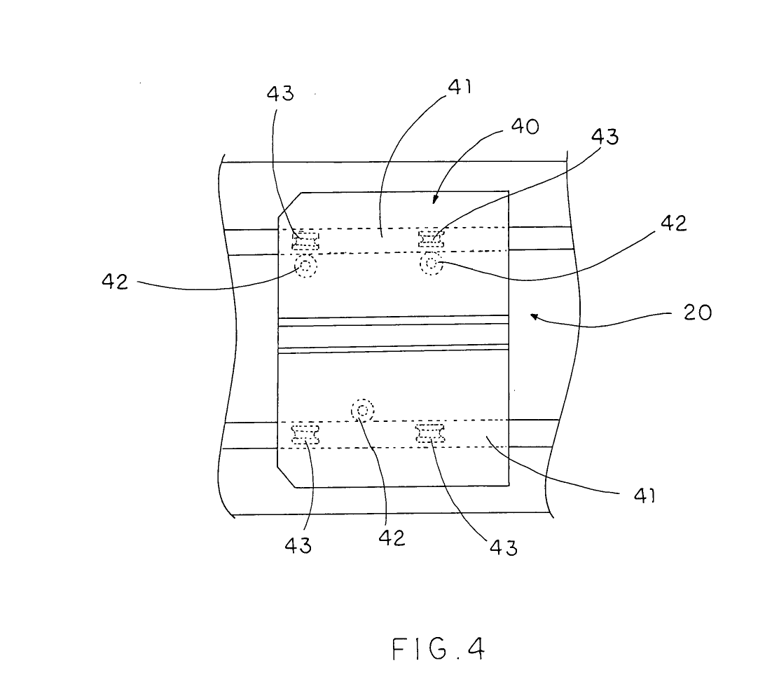

Referring to FIG. 4 of the drawings, the table sliding arrangement 40 according to the preferred embodiment of the present invention comprises three sliding wheels 42 and four alignment wheels 43 spacedly extended along the two longitudinal edges of the cutting table 20 for slidably engaging with the sliding tracks 41.

The cutting table 20 has an outer portion and an inner portion having a length longer than a length of the outer portion, the alignment wheels 43 and the sliding wheels 42 are rotatably positioned at the inner portion of the cutting table 20 in such a manner that the outer portion of the cutting table 20 is adapted to suspendedly slide out of the supporting frame 30 in a stable manner so as to maximize a sliding distance of the cutting table 20 with respect to the supporting frame 30.

Moreover, the cutting table 20 has a cutting platform 21 adapted for supporting the work piece thereon, and four sidewalls 22 (two longitudinal sidewalls and two transverse sidewalls) downwardly and integrally extended from four side edges of the cutting platform 21 to form the cutting table 20, wherein the sliding wheels 42 and the alignment wheels 43 are rotatably mounted on the longitudinal sidewalls 221 for slidably engaging with the corresponding sliding tracks 41.

Each of the sliding tracks 41 further comprises a sliding stopper 414 provided at an outer end of the side sliding channel 412 to stop the sliding wheels 42 sliding out of the side sliding channel 412 so as to allow the outer portion of the cutting table 20 to be stably slid out of the supporting frame 30.

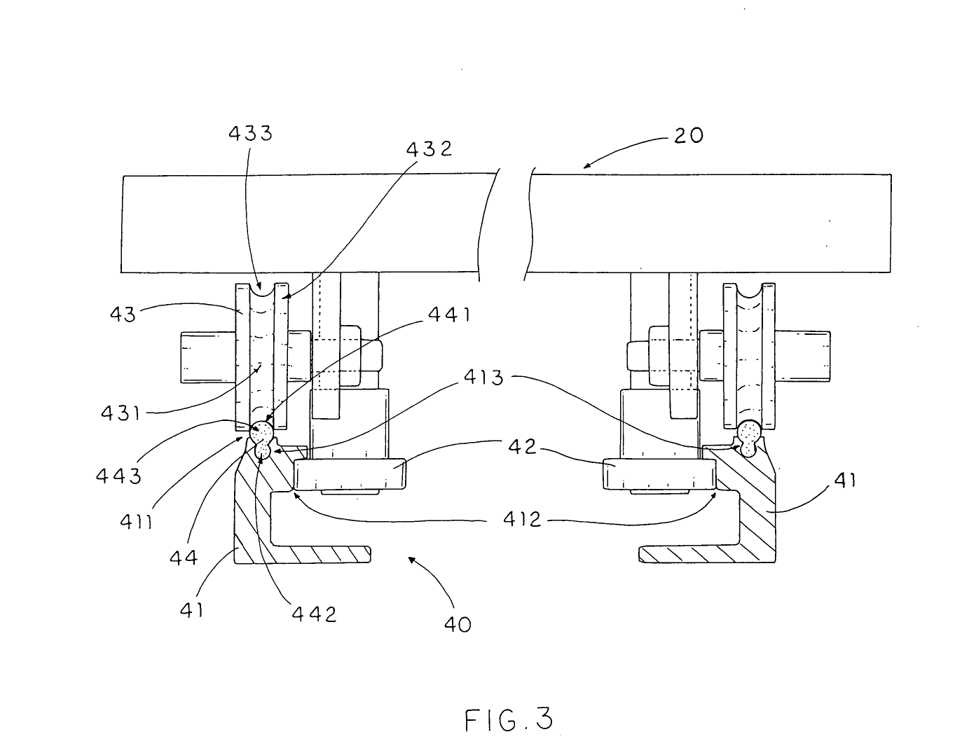

Referring to FIG. 3 of the drawings, each of the sliding runners 44 has a base mounting portion 442 and a head engaging portion 443 defining the convex outer surface 441 of the sliding runner 44, wherein the base mounting portion 442 is adapted to be mounted within the side sliding channel 412 while the head engaging portion 443 is integrally extended from the base mounting portion 442 to slidably engage with the corresponding sliding wheels 42. In particular, the head engaging portion 443 is arranged to receive into the guiding groove 433 of the corresponding alignment wheels 43 for facilitate the sliding movement of the cutting table 20. According to the preferred embodiment of the present invention, the base mounting portion 442 of each of the sliding runners 44 is spherical in shape and is adapted to fittedly mount into the corresponding side sliding channel 412 of the corresponding sliding track 41. Accordingly, each of the side sliding channels 412 has a cross section shaped and sized to correspond with a cross sectional shape of the corresponding sliding runner 44 for securely and fittedly mounting with the sliding runner 44. Therefore, the base mounting portion 442 is detachably received along the sliding groove 413 of the respective sliding track 41 so as to guide the alignment wheels 43 traveling along the top sliding channels 411.

Alternatively, the base mounting portion 442 of each of the sliding runners 44 can be embodied as having an elongated cross section, wherein a connecting pin is required for affixing the base mounting portion 442 with the side sliding channel 412 of the corresponding sliding track 41.

Finally, it is important to stress that the number of sliding wheels 42 and the alignment wheels 43 can be varied as forming different alternatives without violating the spirit of the above preferred embodiment of the present invention. For example, there may only be sliding wheels 42 rotatably mounted on the sliding tracks 41.

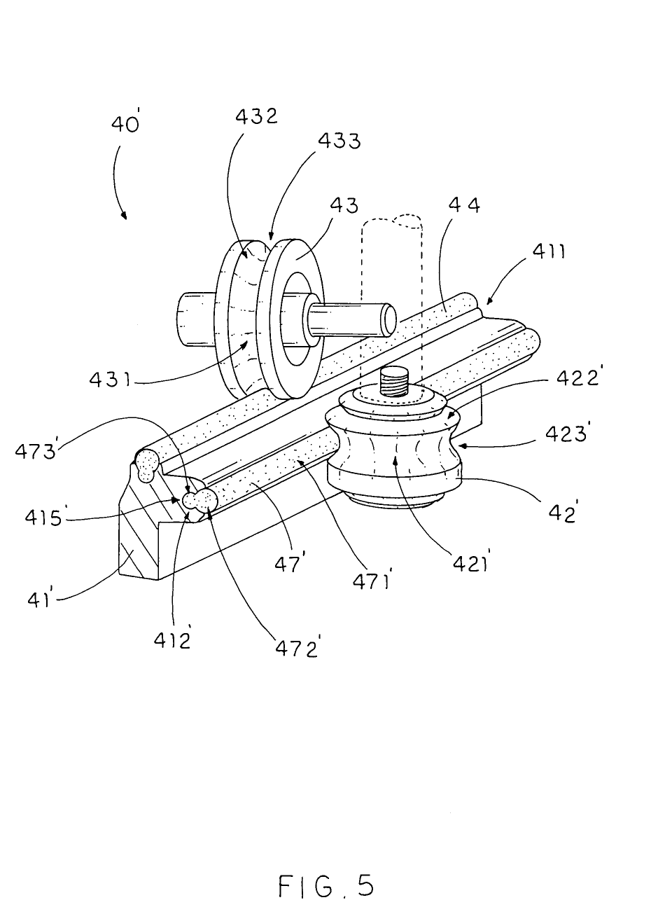

Referring to FIG. 5 of the drawings, a first alternative mode of the power saw machine according to the above preferred embodiment of the present invention is illustrated. The alternative mode is similar to the preferred embodiment except the table sliding arrangement 40′.

According to the first alternative mode, each of the sliding tracks 41 ′ further comprises a side sliding runner 47′, having a side convex surface 471, detachably mounted along the respective side sliding channel 412 ′ such that the sliding wheels 42 ′ are traveling along the side convex surfaces 471 ′ of the side sliding runners 47 ′ respectively to enhance the cutting table 20 smoothly sliding on the supporting frame 30.

Each of the sliding tracks 41 ′ further has an elongated side receiving groove 415 ′ formed along the side sliding channel 412′, wherein each of the side sliding runners 47′, which is identical to the sliding runner 44, has a head engaging portion 472 ′ defining the side convex surface 471 ′ and a base mounting portion 473 ′ detachably receiving along the side receiving groove 415 ′ of the respective side sliding track 41 ′ so as to guide the sliding wheels 42 ′ traveling along the side sliding channels 412′.

As a result, each of the sliding wheels 42 ′ has a central portion 421 ′ and two side rim portions 422 ′ having a diameter larger than a diameter of the central portion 421 ′ to define a guiding groove 423 ′ between the central portion 421 ′ and the side rim portions 422 ′ for slidably engaging with the side sliding runners 47 ′ received in the side sliding channel 412′.

Referring to 6 of the drawings, a second alternative mode of the power saw machine according to the above preferred embodiment of the present invention is illustrated. The second alternative mode is similar to the preferred embodiment except the table sliding arrangement 40″.

According to the second alternative mode, the table sliding arrangement 40″ comprises two sliding tracks 41″ and a plurality of supporting wheels 48″. The two sliding tracks 41″ are spacedly provided at the supporting frame 30, wherein each of the sliding tracks 41 ″ defines an inclined sliding channel 411 ″ therealong.

The supporting wheels 48″ are rotatably, inclinedly, and spacedly mounted underneath the cutting table 20″ to slide along the sliding channels 411″ of the sliding tracks 41 ″ respectively, wherein each of the supporting wheels 48″ is arranged to provide a supporting force which contains a horizontal vector component and a vertical vector components for supporting the cutting table 20″ to slide on the supporting frame 30, in such a manner that the horizontal vector component of the supporting force is adapted to prevent the cutting table 20″ from being flipped over when the cutting table 20″ is sliding on the sliding tracks 41″, and that the vertical vector component of the supporting force is adapted to ensure a proper alignment of the cutting table 20″ when the cutting table 20″ is sliding on the sliding tracks 41″.

Thus, it is important to point out that according to the second alternative mode of the present invention, the sliding wheels 42 and the alignment wheels 43 provide the horizontal vector component and the vertical vector component of the supporting force respectively so that the cutting table 20″ can be slidably supported by the supporting frame 30. In other words, the sliding wheels 42 and the alignment wheels 43 also provide the necessary supporting force of the supporting wheels 48″. The preferred embodiment and the second alternative mode therefore have the same inventive spirit and subject matter. In order to inclinedly mount the supporting wheels 48″ for engaging with the sliding tracks 41″, the table sliding arrangement 40″ further comprises an inclined supporters 49″ provided underneath the cutting table 20″, wherein the inclined supporter 49″ has a vertical supporting portion 491″ downwardly extended from the cutting table 20″, and an inclined supporting portion 492″ inclinedly and upwardly extended from the vertical supporting portion 491″, wherein each of the supporting wheels 48″ is rotatably supported on the inclined supporting portion 492″of the inclined supporter 49″ for inclinedly engaging with the sliding track 41″.

Accordingly, each of the sliding tracks 41″ further has a top neck portion 412″ inclinedly extended therefrom, wherein the sliding channel 411″ is formed on the top neck portion 412″ for substantially aligning with the corresponding supporting wheels 48″. As a result, each of the supporting wheels 48″, being inclined at a predetermined angle, is adapted to slidably engage with the sliding channel 411″ for slidably engaging the cutting table 20″ with the sliding tracks 41″.

Moreover, the table sliding arrangement 40″ further comprises a sliding runner 44″ provided at the sliding channel 411″ of the sliding tracks 41″ for engaging with the supporting wheels 48″ in such a manner that when the supporting wheels 48″ slides on the sliding tracks 41″, the sliding runners 44″ prevent direct physical contact between the sliding tracks 41″ and the supporting wheels 48″ so as to minimize collateral damage of the supporting wheels 48″ and the sliding tracks 41″.

Each of the supporting wheels 48″, as in the case of the alignment wheels 43 and the sliding wheels 42, has a central portion 481″ and two side rim portions 482″ having a diameter larger than a diameter of the central portion 481″ to define a guiding groove 483″ between the central portion 481″ and the side rim portions 482″ for slidably engaging with the respective sliding runners 44″ received in the sliding channel 411″, and so for ensuring the supporting of the cutting table 20″ with respect to the sliding tracks 41″ when the cutting table 20″ slides on the supporting frame 30.

As in the preferred embodiment, each of the sliding runners 44″ has a convex outer surface 441″ which is arrange to physically contact with the corresponding supporting wheels 48″ at an inner surface of the side rim portions 482″ and an outer surface of the central portion 481″ for maximizing a contact surface area between the sliding runner 44″ and the respective supporting wheels 48″ in order to minimize collateral damage between the supporting wheels 48″ and the sliding runners 44″. In other words, the supporting wheels 48″ will be kept in good condition for prolonged usage of the power saw machine of the present invention.

In order to stabilize the sliding movement of the cutting table 20″, a width of each of the guiding grooves 483″ is merely slightly larger than a width of the convex outer surface 441″ of the corresponding sliding runners 44″ so that when the supporting wheels 48″ are engaged with the sliding runners 44″ respectively, a collateral movement between the supporting wheels 48″ are substantially restricted by the width of the guiding grooves 483″ so as to stabilize the sliding movement of the cutting table 20″.

Each of the sliding tracks 41″ further has two runner slots 413″ indently and spacedly formed thereon, and a top protruding portion 414″ integrally and upwardly protruded from a position between the two spacedly apart runner slots 413″, wherein the sliding runner 44″, being elongated in shape, has a head engaging portion 443″ overlappedly mounted onto the protruding portion 414″ of the respective sliding track 41″, and two base mounting portions 442″ securely mounted in the two runner slots 413″ respectively so as to securely mount the sliding runner 44″ to the sliding track 41″. As a result, the head engaging portion 443″ is adapted to slidably engage with the supporting wheels 48″.

Finally, it is worth mentioning that the preferred embodiment and its alternatives may be combined to further form a number of different alternative modes of the present invention without departing the spirits thereof. For example, the sliding runners 44″ and the sliding tracks 41″ as disclosed in the second alternative mode may be used in conjunction with the alignment wheels 43 or the sliding wheels 42 as mentioned in the preferred embodiment.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A power saw machine, comprising:
a cutting head;
a cutting table;
a supporting frame supporting said cutting head; and
a table sliding arrangement, for guiding said cutting table to slide on said supporting frame, which comprises:
two sliding tracks spacedly provided at said supporting frame, wherein each of said sliding tracks has an upper surface defining a top sliding channel therealong and an inner side surface defining a side sliding channel therealong;
a plurality of sliding wheels rotatably, horizontally and spacedly mounted underneath said cutting table to slide along said side sliding channels of said sliding tracks respectively, wherein said cutting table is slidably engaged with said two side sliding channels of said sliding tracks to prevent said cutting table from being flipped over when said cutting table is slid on said supporting frame; and
a plurality of alignment wheels spacedly, vertically and rotatably mounted underneath said cutting table to slide along said top sliding channels of said sliding tracks respectively so as to ensure an alignment of said cutting table to slide on said supporting frame.

2. The power saw machine, as recited in claim 1, wherein each of said alignment wheels has a central portion and two side rim portions having a diameter larger than a diameter of said central portion to define a guiding groove between said side rim portions to slidably engage with said respective top sliding channel, so as to ensure said alignment of said cutting table with respect to said sliding tracks when said cutting table slides on said supporting frame.

3. The power saw machine, as recited in claim 1, wherein each of said sliding tracks has a sliding groove indently formed along said side sliding channel and arranged in such a manner that said sliding wheels are slidably engaged with said sliding grooves to slide along said side sliding channel respectively so as to prevent an unwanted sideward movement of said cutting table when said cutting table slides on said supporting frame.

4. The power saw machine, as recited in claim 2, wherein each of said sliding tracks has a sliding groove indently formed along said side sliding channel and arranged in such a manner that said sliding wheels are slidably engaged with said sliding grooves to slide along said side sliding channel respectively so as to prevent an unwanted sideward movement of said cutting table when said cutting table slides on said supporting frame.

5. The power saw machine, as recited in claim 1, wherein said cutting table has an outer portion and an inner portion having a length longer than a length of said outer portion, wherein said alignment wheels and said sliding wheels are rotatably positioned at said inner portion of said cutting table in such a manner that said outer portion of said cutting table is adapted to suspendedly slide out of said supporting frame in a stably manner to maximize a sliding distance of said cutting table with respect to said supporting frame.

6. The power saw machine, as recited in claim 3, wherein said cutting table has an outer portion and an inner portion having a length longer than a length of said outer portion, wherein said alignment wheels and said sliding wheels are rotatably positioned at said inner portion of said cutting table in such a manner that said outer portion of said cutting table is adapted to suspendedly slide out of said supporting frame in a stably manner to maximize a sliding distance of said cutting table with respect to said supporting frame.

7. The power saw machine, as recited in claim 4, wherein said cutting table has an outer portion and an inner portion having a length longer than a length of said outer portion, wherein said alignment wheels and said sliding wheels are rotatably positioned at said inner portion of said cutting table in such a manner that said outer portion of said cutting table is adapted to suspendedly slide out of said supporting frame in a stably manner to maximize a sliding distance of said cutting table with respect to said supporting frame.

8. The power saw machine, as recited in claim 5, wherein each of said sliding tracks further comprises a sliding stopper provided at an outer end of said side sliding channel to stop said sliding wheels sliding out of said side sliding channel so as to allow said outer portion of said cutting table being stably slid out of said supporting frame.

9. The power saw machine, as recited in claim 6, wherein each of said sliding tracks further comprises a sliding stopper provided at an outer end of said side sliding channel to stop said sliding wheels sliding out of said side sliding channel so as to allow said outer portion of said cutting table being stably slid out of said supporting frame.

10. The power saw machine, as recited in claim 7, wherein each of said sliding tracks further comprises a sliding stopper provided at an outer end of said side sliding channel to stop said sliding wheels sliding out of said side sliding channel so as to allow said outer portion of said cutting table being stably slid out of said supporting frame.

11. The power saw machine, as recited in claim 2, wherein said table sliding arrangement further comprises a sliding runner detachably mounted along said respective top sliding channel, wherein said sliding runner has a top convex surface substantially engaging with said guiding grooves of said alignment wheels to allow said alignment wheels smoothly sliding along said side sliding channel so as to minimize a collateral damage between said alignment wheels and said sliding runners.

12. The power saw machine, as recited in claim 7, wherein said table sliding arrangement further comprises a sliding runner detachably mounted along said respective top sliding channel, wherein said sliding runner has a top convex surface substantially engaging with said guiding grooves of said alignment wheels to allow said alignment wheels smoothly sliding along said side sliding channel so as to minimize a collateral damage between said alignment wheels and said sliding runners.

13. The power saw machine, as recited in claim 10, wherein said table sliding arrangement further comprises a sliding runner detachably mounted along said respective top sliding channel, wherein said sliding runner has a top convex surface substantially engaging with said guiding grooves of said alignment wheels to allow said alignment wheels smoothly sliding along said side sliding channel so as to minimize a collateral damage between said alignment wheels and said sliding runners.

14. The power saw machine, as recited in claim 11, wherein each of said sliding tracks has two runner slots indently and spacedly formed thereon, and a top protruding portion integrally and upwardly protruded from a position between said two runner slots, wherein said sliding runner, being elongated in shape, has a head engaging portion overlappedly mounted onto said protruding portion of said respective sliding track, and two base mounting portions securely mounted in said two runner slots respectively so as to securely mount said sliding runner to said sliding track.

15. A power saw machine, comprising:
a cutting head;
a cutting table;
a supporting frame supporting said cutting head; and
a table sliding arrangement, for guiding said cutting table to slide on said supporting frame, which comprises:
two sliding tracks spacedly provided at said supporting frame, wherein each of said sliding tracks has an upper surface defining a top sliding channel therealong and comprises a sliding runner, having a top convex surface, detachably mounted along said respective top sliding channel; and
a plurality of alignment wheels spacedly, vertically and rotatably mounted underneath said cutting table to slide along said top sliding channels of said sliding tracks respectively to ensure an alignment of said cutting table to slide on said supporting frame, wherein each of said alignment wheels has a central portion and two side rim portions having a diameter larger than a diameter of said central portion to define a guiding groove between said side rim portions to slidably engage with said respective sliding runner to allow said alignment wheels smoothly sliding along said side sliding channel so as to minimize a collateral damage between said alignment wheels and said sliding runners.

16. The power saw machine, as recited in claim 15, wherein each of sliding tracks further has an elongated receiving groove formed along said top sliding channel, wherein each of said sliding runners further has a head engaging portion defining said top convex surface and a base mounting portion detachably receiving along said receiving groove of said respective sliding track so as to guide said alignment wheels traveling along said top sliding channels.

17. The power saw machine, as recited in claim 16, wherein said head engaging portion and said base mounting portion of each of said sliding runners are circular in shape for evenly disturbing a downward force of said cutting table to said sliding tracks when said alignment wheels travel therealong.

18. The power saw machine, as recited in claim 15, wherein table sliding arrangement further has a side sliding channel formed along an inner side surface of each of said sliding tracks and comprises a second set of alignment wheels as sliding wheels rotatably, horizontally and spacedly mounted underneath said cutting table to slide along said side sliding channels of said sliding tracks respectively to prevent said cutting table from being flipped over when said cutting table is slid on said supporting frame.

19. The power saw machine, as recited in claim 16, wherein table sliding arrangement further has a side sliding channel formed along an inner side surface of each of said sliding tracks and comprises a second set of alignment wheels as sliding wheels rotatably, horizontally and spacedly mounted underneath said cutting table to slide along said side sliding channels of said sliding tracks respectively to prevent said cutting table from being flipped over when said cutting table is slid on said supporting frame.

20. The power saw machine, as recited in claim 17, wherein each of said sliding tracks further comprises a side sliding runner, having a side convex surface, detachably mounted along said respective side sliding channel such that said sliding wheels are traveling along said side convex surfaces of said side sliding runners respectively to enhance said cutting table smoothly sliding on said supporting frame.

21. The power saw machine, as recited in claim 20, wherein each of said sliding tracks further comprises a side sliding runner, having a side convex surface, detachably mounted along said respective side sliding channel such that said sliding wheels are traveling along said side convex surfaces of said side sliding runners respectively to enhance said cutting table smoothly sliding on said supporting frame.

22. The power saw machine, as recited in claim 20, wherein each of sliding tracks further has an elongated side receiving groove formed along said side sliding channel, wherein each of said side sliding runners, which is identical to said sliding runner, has a head engaging portion defining said side convex surface and a base mounting portion detachably receiving along said side receiving groove of said respective side sliding track so as to guide said sliding wheels traveling along said side sliding channels.

23. The power saw machine, as recited in claim 21, wherein each of sliding tracks further has an elongated side receiving groove formed along said side sliding channel, wherein each of said side sliding runners, which is identical to said sliding runner, has a head engaging portion defining said side convex surface and a base mounting portion detachably receiving along said side receiving groove of said respective side sliding track so as to guide said sliding wheels traveling along said side sliding channels.

24. The power saw machine, as recited in claim 22, wherein each of said sliding tracks further comprises a sliding stopper provided at an outer end of said side sliding channel to stop said sliding wheels sliding out of said side sliding channel.

25. The power saw machine, as recited in claim 23, wherein each of said sliding tracks further comprises a sliding stopper provided at an outer end of said side sliding channel to stop said sliding wheels sliding out of said side sliding channel.

26. The power saw machine, as recited in claim 15, wherein each of said sliding tracks has two runner slots indently and spacedly formed thereon, and a top protruding portion integrally and upwardly protruded from a position between said two runner slots, wherein said sliding runner, being elongated in shape, has a head engaging portion overlappedly mounted onto said protruding portion of said respective sliding track, and two base mounting portions securely mounted in said two runner slots respectively so as to securely mount said sliding runner to said sliding track.

27. A power saw machine, comprising:
a cutting head;
a cutting table;
a supporting frame supporting said cutting head; and
a table sliding arrangement, for guiding said cutting table to slide on said supporting frame, which comprises:
two sliding tracks spacedly provided at said supporting frame, wherein each of said sliding tracks defines an inclined sliding channel therealong; and
a plurality of supporting wheels rotatably, inclinedly, and spacedly mounted underneath said cutting table to slide along said sliding channels of said sliding tracks respectively, wherein each of said supporting wheels is arranged to provide a supporting force which contains a horizontal vector component and a vertical vector component for supporting said cutting table to slide on said supporting frame, in such a manner that said horizontal vector component of said supporting force is adapted to prevent said cutting table from being flipped over when said cutting table slides on said sliding tracks, and that said vertical vector component of said supporting force is adapted to ensure a proper alignment of said cutting table when said cutting table slides along said sliding tracks.

28. The power saw machine, as recited in claim 27, wherein said table sliding arrangement further comprises an inclined supporter provided underneath said cutting table, wherein said inclined supporter has a vertical supporting portion downwardly extended from said cutting table, and an inclined supporting portion upwardly and inclinedly extended from said vertical supporting portion to form a substantially V-shaped cross section of said inclined supporter, wherein each of said supporting wheels is rotatably supported on said inclined supporting portion of said inclined supporter for inclinedly engaging with said corresponding sliding track.

29. The power saw machine, as recited in claim 28, wherein each of said sliding tracks further has a top neck portion inclinedly extended therefrom, wherein said sliding channel is formed on said top neck portion for substantially aligning with said corresponding supporting wheels, so that each of said supporting wheels, being inclined at a predetermined angle, is adapted to slidably engage with said sliding channel for slidably engaging said cutting table with said sliding tracks.

30. The power saw machine, as recited in claim 29, wherein said table sliding arrangement further comprises a sliding runner provided at said sliding channel of said sliding tracks for engaging with said supporting wheels in such a manner that when said supporting wheels slide on said sliding tracks, said sliding runners prevent direct physical contact between said sliding tracks and said supporting wheels so as to minimize collateral damage of said supporting wheels and said sliding tracks.

31. The power saw machine, as recited in claim 30, wherein each of said supporting wheels has a central portion and two side rim portions having a diameter larger than that of said central portion to define a guiding groove between said central portion and said side rim portions for slidably engaging with said respective sliding runners received in said sliding channel, and so for ensuring secure supporting of said cutting table with respect to said sliding tracks when said cutting table slides on sliding tracks.

32. The power saw machine, as recited in claim 31, wherein each of said sliding tracks has a sliding groove indently formed along said sliding channel, wherein each of said sliding runners has a convex outer surface which is arrange to physically contact with said supporting wheels at an inner surface of said side rim portions and an outer surface of said central portion for maximizing a contact surface area between said sliding runner and said respective supporting wheel.

33. The power saw machine, as recited in claim 32, wherein each of said sliding runners further has a base mounting portion and a head engaging portion defining said convex outer surface of said sliding runner, wherein said base mounting portion is adapted to be mounted at said sliding channel while said head engaging portion is integrally extended from said base mounting portion to slidably engage with said corresponding supporting wheels.

34. The power saw machine, as recited in claim 31, wherein each of said sliding tracks has two runner slots indently and spacedly formed thereon, and a top protruding portion integrally and upwardly protruded from a position between said two runner slots, wherein said sliding runner, being elongated in shape, has a head engaging portion overlappedly mounted onto said protruding portion of said respective sliding track, and two base mounting portions securely mounted in said two runner slots respectively so as to securely mount said sliding runner to said sliding track.
